(19) United States
(12) Patent Application Publication
(10) Pub. No.: US 2024/0194856 A1
(43) Pub. Date: Jun. 13, 2024

(54) BATTERY CELL HAVING IMPROVED SAFETY

(71) Applicant: SK ON CO., LTD., Seoul (KR)

(72) Inventors: John Cronin, Jericho, VT (US); So Eun KIM, Daejeon (KR); Soo Min PARK, Daejeon (KR); Hyung Ju PAIK, Daejeon (KR); Hae Ryong JEON, Daejeon (KR)

(21) Appl. No.: 18/352,242

(22) Filed: Jul. 14, 2023

Related U.S. Application Data
(60) Provisional application No. 63/430,900, filed on Dec. 7, 2022.

(51) Int. Cl. H01M 4/36; H01M 50/15

(52) U.S. Cl. CPC H01M 4/362; H01M 50/15; H01M 2004/021

(57) ABSTRACT

A battery cell including an electrode assembly including an active material and a foil and a can accommodating the electrode assembly is provided. The foil may include a first region covered with the active material and having a first thickness, a second region covered with the active material and extending from the first region, and a third region protruding from the second region, The third region may have a third thickness, greater than the first thickness, and the second region may have a second thickness, greater than the first thickness and less than the third thickness.

### CROSS-REFERENCE TO RELATED APPLICATION (S)

This patent document claims the benefit of U.S. Provisional Patent Application No. 63/430,900 filed on Dec. 7, 2022, the disclosure of which is incorporated herein by reference in its entirety.

### TECHNICAL FIELD

The present disclosure relates to a battery cell having improved safety. More specifically, this document relates to a battery cell including a foil that can improve the safety and performance of prismatic battery cells.

### BACKGROUND

Heat may be generated in prismatic battery cells due to charging or discharging of battery cells. Performance of battery cells may deteriorate due to heat accumulated in battery cells. In addition, a short circuit may occur inside battery cells due to the generated heat, and ignition may occur in battery cells. A structure of battery cells for reducing heat generation inside battery cells has been studied.

### SUMMARY

An electrode assembly may include a portion coated with an active material and an uncoated portion electrically connected to an external terminal. However, when current passes through the protruding uncoated portion, resistance may increase and heat generation may occur due to a current bottleneck.

An increase in resistance and local heat generation may cause a decrease in capacity of a battery cell or a decrease in lifespan of the battery cell.

Present disclosure may be implemented in some embodiments to provide a battery cell capable of reducing resistance and heat generation due to a current bottleneck.

In some embodiments of the disclosure, a battery cell includes an electrode assembly including an active material and a foil; and a can accommodating the electrode assembly. The foil includes: a first region covered with the active material and having a first thickness; a second region covered with the active material and extending from the first region; and a third region protruding from the second region, wherein the third region has a third thickness, greater than the first thickness, and the second region has a second thickness, greater than the first thickness and less than the third thickness.

According to an embodiment, the second region may be formed to gradually be thicker as it is closer to the third region than the first region.

According to an embodiment, the first thickness may be uniform. The second region may be tapered.

According to an embodiment, the third region may not be covered with the active material.

According to an embodiment, the third thickness may be uniform.

According to an embodiment, the third thickness may increase in a direction away from the second region.

According to an embodiment, the active material may include a first cover region having a fourth thickness, being uniform, and a second cover region having a fifth thickness less than the fourth thickness.

According to an embodiment, the first cover region may be disposed on the first region, and the second cover region may be disposed on the second region.

According to an embodiment, a ratio of the third thickness to the first thickness may be equal to a ratio of a total width of the electrode assembly to a sum of the width of the third region.

According to an embodiment, the foil may have an arcuate or tapered width.

According to an embodiment, the foil may include a protruding region protruding from the first region and not covered with the active material. The first region may be located between the protruding region and the second region.

According to an embodiment, the foil may include a cathode foil and an anode foil, and the active material may include a positive electrode active material applied on the cathode foil and a negative electrode active material applied on the anode foil.

According to an embodiment, the battery cell may further include: an upper cap assembly connected to the can and including a cathode terminal connected to the third region of the cathode foil and an anode terminal connected to the third region of the anode foil.

### BRIEF DESCRIPTION OF DRAWINGS

Certain aspects, features, and advantages of the present disclosure are illustrated by the following detailed description with reference to the accompanying drawings.

FIG. 1 is a perspective view of a battery cell according to an embodiment.

FIGS. 2A, 2B, and 2C are views illustrating an upper cap assembly according to an embodiment.

FIGS. 3A to 3F are a view illustrating an assembly process of an upper cap assembly and an electrode assembly according to an embodiment.

FIGS. 4A to 4F are a view illustrating an assembly process of an electrode assembly, a jelly roll bag, and a can according to an embodiment.

FIGS. 5A and 5B are views illustrating connection between a jelly roll and an upper cap assembly according to an embodiment.

FIGS. 6A, 6B, 6C, and 6D are views illustrating a foil roll and a die-cutting process according to a comparative example.

FIGS. 7A and 7B are views illustrating a relationship between an arc radius and a current density according to an embodiment.

FIGS. 8A, 8B, and 8C are views illustrating a foil having a variable width according to an embodiment.

FIG. 9A is a view illustrating an electrode plate including a foil having a variable thickness according to an embodiment. FIG. 9B is a cross-sectional perspective view of a cross-section B-B′ of FIG. 9A.

FIG. 10 illustrates an electrode plate comprising an active material having a variable thickness according to an embodiment.

FIG. 11A is a schematic diagram of an electrode plate including and foil having a variable thickness and an active material according to an embodiment. FIG. 11B is a schematic diagram of an electrode plate including an active material having a variable thickness, according to an embodiment.

### DETAILED DESCRIPTION

Embodiments of the present disclosure will be more fully described below with reference to the accompanying drawings, in which like symbols indicate like elements throughout the drawings, and embodiments are shown. However, embodiments of the claims may be implemented in many different forms and are not limited to the embodiments described herein. The examples given herein are non-limiting and only examples among other possible examples.

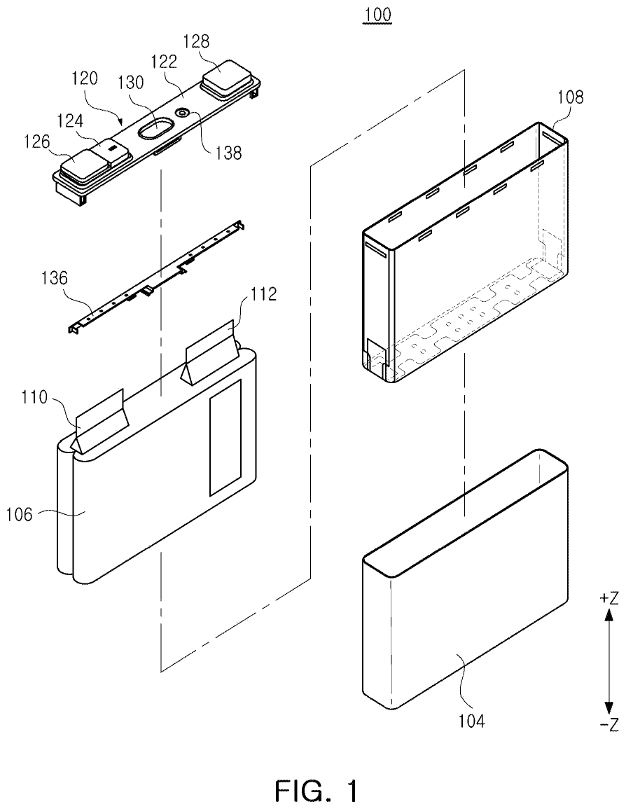

FIG. 1 is an exploded perspective view of a battery cell according to an embodiment.

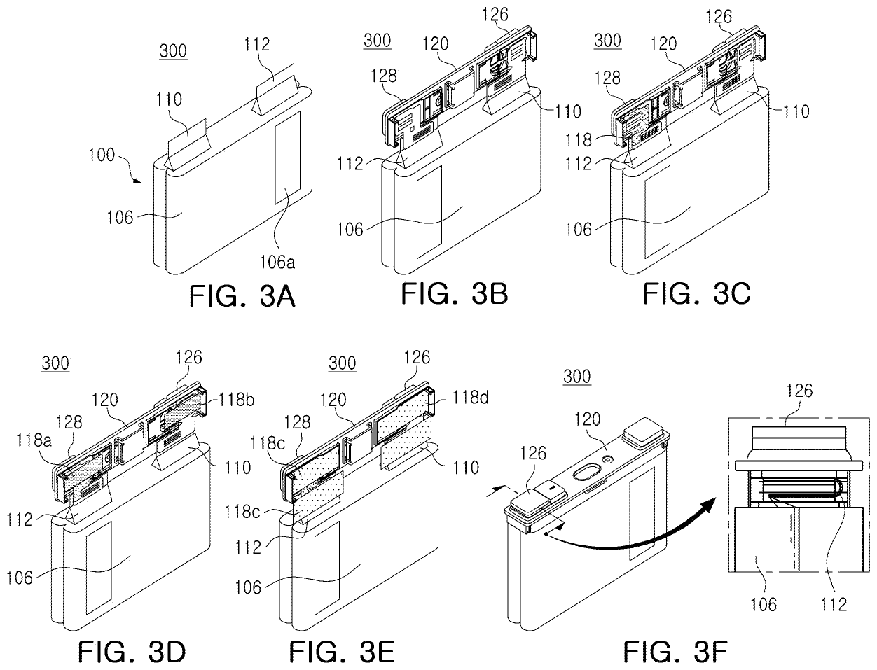

Referring to FIG. 1, a battery cell 100 may be a prismatic cell. Prismatic cells are widely used in powertrains of electric vehicles. The prismatic cells may be stacked together in a rectangular shape, allowing more efficient use of space. Prismatic cells are generally rectangular and have a higher power density than cylindrical cells. Prismatic cells also provide better performance in cold weather and less damage from vibration. However, prismatic cells may be more expensive to manufacture than cylindrical cells. In addition, prismatic cells are less likely to fail due to vibration or movement. Prismatic cells may deliver more power than cylindrical battery cells due to spatial optimization of the rectangular shape thereof. The prismatic battery cell 100 includes a rectangular can 104 that may be formed of steel, aluminum, aluminum alloy, plastic, or other metals having sufficient structural strength. The can 104 may be manufactured according to various different methods including deep draw or impact extrusion. The method for manufacturing the can 104 may be combined with wall ironing to achieve the final geometry, thickness and tolerances. The can 104 may be wrapped with cell cover tape. A jelly roll 106 includes a stacked anode, cathode and separator. A jelly roll 106 type electrode assembly configured to have a structure of a long sheet type cathode and a long sheet type anode to which an active material is applied is wound. At the same time, the stacked-type electrode assembly has a structure in which a separator is disposed between a cathode and an anode or has a structure in which a plurality of cathodes and anodes having a predetermined size are sequentially stacked and a separator is disposed between each of the cathodes and the anode. The jelly roll-type electrode assembly is easy to manufacture and has high unit mass and energy density, compared to a sheet-type electrode assembly. In some batteries, one or more jelly rolls 106 are inserted into can 104. Each jelly roll 106 electrode assembly is included inside a polymer jelly roll bag 108 sealed inside the can 104. Each jelly roll 106 includes a cathode foil 112 formed of aluminum. The aluminum foil is coated with the electrode slurry. A first operation of electrode manufacturing is a slurry mixing process in which an active raw material is combined with a binder, a solvent and an additive. This mixing process should be performed separately for anode and cathode slurries. Viscosity, density, solids content and other measurable properties of the slurry affect battery quality and electrode uniformity. For example, a slurry having a faster drying rate, a higher solids content, a lower rate capability, and a low viscosity is generated as a solvent content is higher. Thereafter, the cathode slurry is applied to an aluminum foil and dried. A slot die coater is a method of coating a foil in which a slurry is spread through slot gaps on the moving foil receiving tension over rollers. In some embodiments, this may be performed simultaneously on both sides of the foil. This production method enables high speed, while achieving precision in coating thickness. A drying process may be incorporated into a continuous coating. The drying process should achieve three objectives: diffusion of the binder, sedimentation of particles, and evaporation of the solvent. Air floatation is a method of drying the slurry on the foil. Uniformity of the electrode coating and drying process affects the safety, consistency and life cycle of the prismatic battery cell 100. The electrode should go through a calendaring process in which electrode porosity and twist are controlled by compressing the coated electrode sheet to a uniform thickness and density. Each jelly roll 106 includes an anode foil 110 formed of copper foil. The anode foil 110 is provided similarly to a cathode foil 112. Each jelly roll 106 may include a cathode connector (not shown) that makes an electrical connection between the inner end portion of the cathode foil 112 and the cathode terminal 128. Each jelly roll 106 may include an anode connector (not shown) that makes an electrical connection between the inner end portion of the anode foil 110 and an anode terminal 126. Each jelly roll 106 may include a cathode connector mask (e.g., a cathode connector mask 118 in FIG. 3C).

Each prismatic battery cell 100 may have an upper cap assembly 120 welded or otherwise bonded to the top of the can 104. The upper cap assembly 120 may include a base plate 122 attached to the can 104. The base plate 122 isolates the inside and outside of the cell by welding with the can 104. The base plate 122 may serve as a rigid support structure for elements within the upper cap assembly 120. The upper cap assembly 120 may include a plurality of upper insulators 124 to insulate the base plate 122. The upper insulator 124 may prevent leakage of an electrolyte from the prismatic battery cell 100. Additionally, the upper insulator 124 may isolate the can 104 from the cathode foil 112 and prevent penetration of moisture and gases from the outside of the cell. A portion of the upper insulator 124 may protect a current interrupting device. The upper cap assembly 120 includes a cathode terminal 128 electrically connecting the inside and outside of the prismatic battery cell 100. The upper cap assembly 120 includes an anode terminal 126 electrically connecting the inside and outside of the prismatic battery cell 100.

The upper cap assembly 120 may include a vent 130 allowing exhaust gases from the prismatic battery cell 100 to be discharged in a controlled direction and at a controlled pressure. The upper cap assembly 120 may include a vent guard 132 protecting the vent 130 from the inside of the prismatic battery cell 100 in order to prevent the vent 130 from malfunctioning. The upper cap assembly 120 may include an overcharge safety device 134 preventing an external current from being introduced using an internal gas pressure of the prismatic battery cell 100. The upper insulator 124 may be multi-component. In some embodiments, side portions of the upper insulator 124 may be mounted on the edges of the can 104 and the upper cap assembly 120. An electrolyte cap 138 may seal an electrolyte solution inside the prismatic battery cell 100.

The battery cell 100 may include an insulator 136 located between the upper cap assembly 120 and the can 104.

In this document, the electrode assembly of the battery cell 100 is described as the jelly roll 106, but the electrode assembly of the battery cell 100 is not limited to the jelly roll 106. For example, the jelly roll 106 may be replaced with a stack type electrode assembly or a Z-folding type electrode assembly. According to an embodiment, the jelly roll 106 described herein may refer to an electrode assembly.

In this document, the can 104 may be referred to as a case or housing.

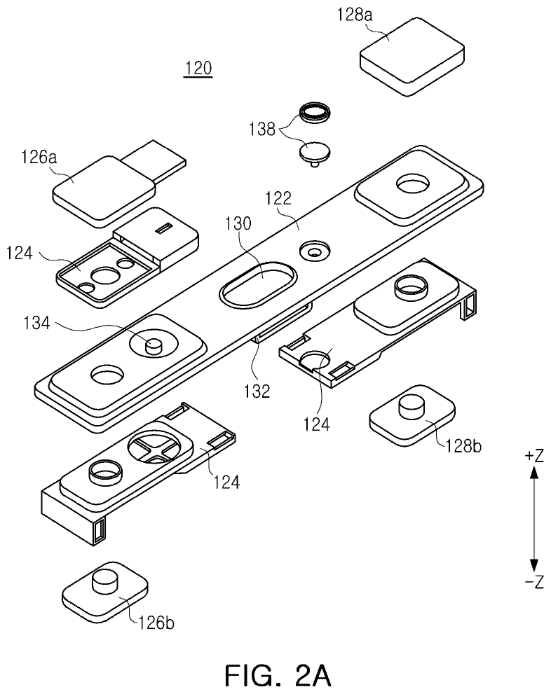

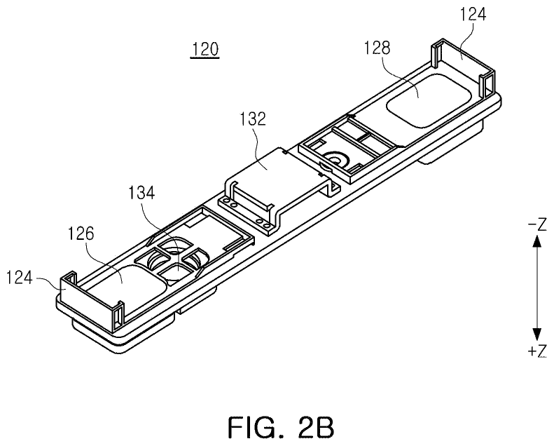

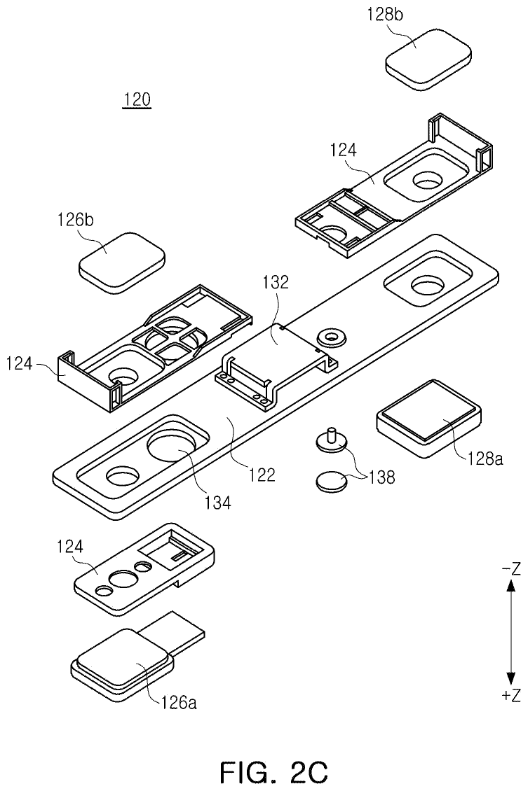

FIGS. 2A, 2B and 2C show a configuration and component functions of the upper cap assembly 120. For example, FIG. 2A is an exploded perspective view of the upper cap assembly 120 according to an embodiment of the present disclosure. FIG. 2B is a rear perspective view of the upper cap assembly 120 according to an embodiment of the present disclosure. Description of the upper cap assembly 120 of FIG. 1 may be applied to the upper cap assembly 120 of FIGS. 2A, 2B and 2C.

The upper cap assembly 120 serving as a cover for the prismatic battery cell 100 is a complex assembly including a plurality of welded components. Adhesives may be used instead of welding specific components.

The prismatic battery cell 100 may include the vent 130. The vent 130 provides overpressure alleviation when temperature and corresponding pressure increase in the prismatic battery cell 100. For example, the vent 130 may be activated in a pressure range of 10 to 15 bar. The vent 130 may be laser-welded to the upper cap assembly 120.

The prismatic battery cell 100 may include the can 104. The can 104 may generally be formed of deep-drawn aluminum or stainless steel to prevent moisture from entering the cell, while providing diffusion resistance to organic solvents, such as liquid electrolytes. The most important reason the can 104 is typically formed of deep-drawn aluminum alloy or stainless steel is to reduce a welding point to improve the mechanical strength of the can 104. The prismatic battery cell 100 may be filled with an electrolyte. After electrolyte filling, the electrolyte cap 138 may be welded to the upper cap assembly 120 or a locking ball (not shown) may be forced into an opening of the electrolyte cap 138. The cell may have an overcharge safety device 134 that may disconnect current flow when high internal pressure is reached in the prismatic battery cell 100. A rise in pressure is usually a result of high temperatures.

According to an embodiment, the cathode terminal 128 may be provided in plural. For example, the cathode terminal 128 may include a first cathode terminal 128a in which at least a portion is exposed to the outside of the battery cell 100 and a second cathode terminal 128b connected to a cathode foil (e.g., the cathode foil 112 of FIG. 1). The second cathode terminal 128b may be electrically connected to the first cathode terminal 128a. For example, a portion of the second cathode terminal 128b may contact the first cathode terminal 128a.

According to an embodiment, the anode terminal 126 may be provided in plural. For example, the anode terminal 126 may include a first anode terminal 126a in which at least a portion is exposed to the outside of the battery cell 100 and a second anode terminal 126b connected to an anode foil (e.g., the anode foil 110 of FIG. 1). The second anode terminal 126b may be electrically connected to the first anode terminal 126a. For example, a portion of the second anode terminal 126b may contact the first anode terminal 126a.

FIGS. 3A to 3F are a view illustrating an assembly process of an upper cap assembly and an electrode assembly according to an embodiment. A battery cell manufacturing process 300 may include an assembly process of the upper cap assembly 120 and the jelly roll 106.

Referring to FIG. 3A, a sealing tape 106a may be attached to the jelly roll 106. According to an embodiment, the sealing tape 106a can cover at least a portion of the jelly roll 106. According to an embodiment, the sealing tape 106a may seal a portion of the jelly roll 106.

Referring to FIG. 3B, the jelly roll 106 may be connected to the upper cap assembly 120. For example, a connection component for connecting the jelly roll 106 and the upper cap assembly 120 may be prepared. The upper cap assembly 120 may be closely attached to the jelly roll 106 using the connection component. For example, the cathode terminal 128 of the upper cap assembly 120 may be connected to the cathode foil 112 of the jelly roll 106, and the anode terminal 126 of the upper cap assembly 120 may be connected to the jelly roll 106. The cathode terminal 128 may be welded to the cathode foil 112 and the anode terminal 126 may be welded (e.g., ultrasonic-welded) to the anode foil 110.

Referring to FIG. 3C, at least a portion of the cathode terminal 128 may be masked. For example, the cathode connector mask 118 may be disposed to cover a portion of the cathode terminal 128. The cathode connector mask 118 may protect the cathode terminal 128. Although not shown, the description of the masking of the cathode terminal 128 may be applied to the anode terminal 126 as well.

Referring to FIG. 3D and/or FIG. 3E, tape may be attached to at least a portion of the cathode terminal 128 and the anode terminal 126. For example, the battery cell 100 may include welding tapes 118a, 118b, 118c, and 118d attached to at least a portion of the cathode terminal 128, the anode terminal 126, the cathode foil 112, and/or the anode foil 110. According to an embodiment, the welding tapes 118a, 118b, 118c, 118d may be attached to at least a portion of a joint portion of the cathode terminal 128, the anode terminal 126, the cathode foil 112, and/or the anode foil 110. As the joint portion is covered with the welding tapes 118a, 118b, 118c, and 118d, the cathode terminal 128 and the anode terminal 126 may be protected.

Referring to FIG. 3F, the anode foil 110 connected to the anode terminal 126 may be folded. For example, when the upper cap assembly 120 is disposed on the jelly roll 106, at least a portion of the anode foil 110 may be folded. Although not shown, when the upper cap assembly 120 is placed on the jelly roll 106, the cathode foil 112 may also be folded.

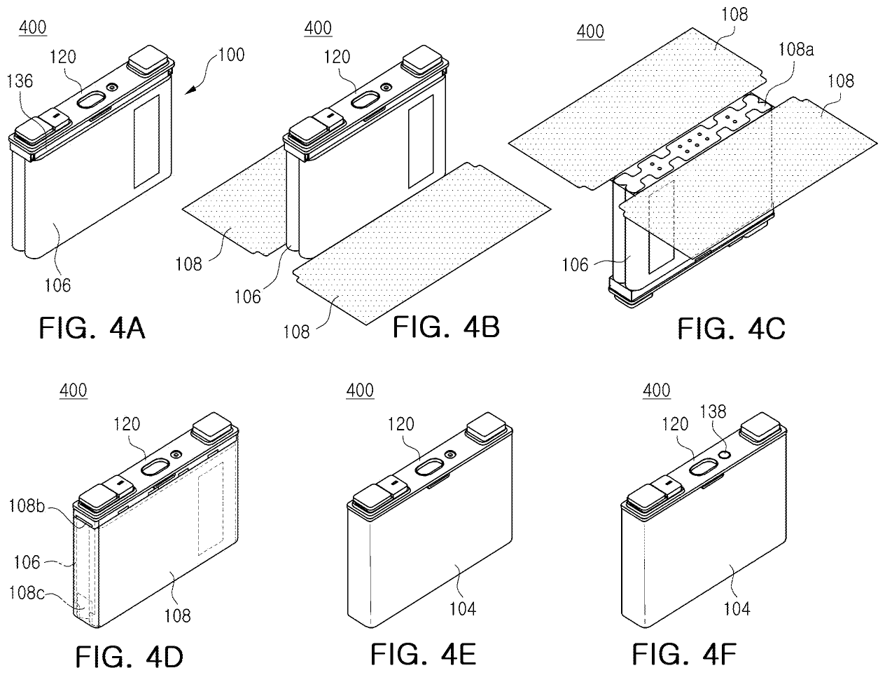

FIGS. 4A to 4F are a view illustrating an assembly process of an electrode assembly, a jelly roll bag, and a can. A battery cell manufacturing process 400 may include an assembly process of the jelly roll 106, the jelly roll bag 108, and the can 104.

Referring to FIG. 4A, an insulator 136 may be installed on the battery cell 100. For example, the insulator 136 may be disposed between the can 104 and the cap assembly 120.

Referring to FIG. 4B, the jelly roll bag 108 may be prepared. The jelly roll bag 108 may cover at least a portion (e.g., a side surface) of the jelly roll 106. The jelly roll 106 may be surrounded by the jelly roll bag 108. The jelly roll bag 108 may protect the jelly roll 106 from external impact. In FIG. 4B, a structure in which the jelly roll bag 108 is disposed on two side surfaces of the jelly roll 106 is shown, but the structure of the jelly roll bag 108 is not limited thereto. For example, according to an embodiment, the jelly roll bag 108 may be formed to cover four side surfaces of the jelly roll 106.

Referring to FIG. 4C, an insulator 108a may be attached to the jelly roll 106. According to an embodiment, in a state in which the jelly roll bag 108 is unfolded, the insulator 108a may be attached to a lower portion of the jelly roll 106. The insulator 108a may be referred to as a lower insulator.

Referring to FIG. 4D, at least some of the components of the battery cell 100 may be taped. For example, the battery cell 100 may include the upper cap assembly 120, the can 104, and/or at least one first tape 108b attached onto insulator 136, and/or a second tape 108c attached to a lower portion of the jelly roll bag 108 along a side portion of the insulator 136.

Referring to FIG. 4E, the jelly roll 106 may be inserted into the can 104. The jelly roll 106 and/or the jelly roll bag 108 may be inserted into the can 104.

According to an embodiment, the battery cell manufacturing process 400 may include a wetting process of the jelly roll 106. For example, the jelly roll 106 may be initially wetted by an electrolyte delivered through an electrolyte injection port. For example, partial vacuum may be formed in the prismatic battery cell 100, and a predetermined amount of electrolyte may be injected through the electrolyte injection port. The partial vacuum may improve the distribution and wetting of all layers within the jelly roll 106. Wetting of all layers within the jelly roll 106 may require a rolling or spinning protocol to enhance wetting.

According to an embodiment, the battery cell manufacturing process 400 may include a quality check process for the initial wetting process, such as checking a weight of the prismatic battery cell 100 immediately after charging. For example, a second electrolyte charging operation in which an electrolyte is charged to achieve a desired weight may be applied to the battery cell. According to an embodiment, the battery cell manufacturing process 400 may include a pre-formation process of charging the prismatic battery cell 100 and discharging gas.

Referring to FIG. 4F, the electrolyte injection port may be sealed. For example, the electrolyte cap 138 may be inserted into the electrolyte injection port.

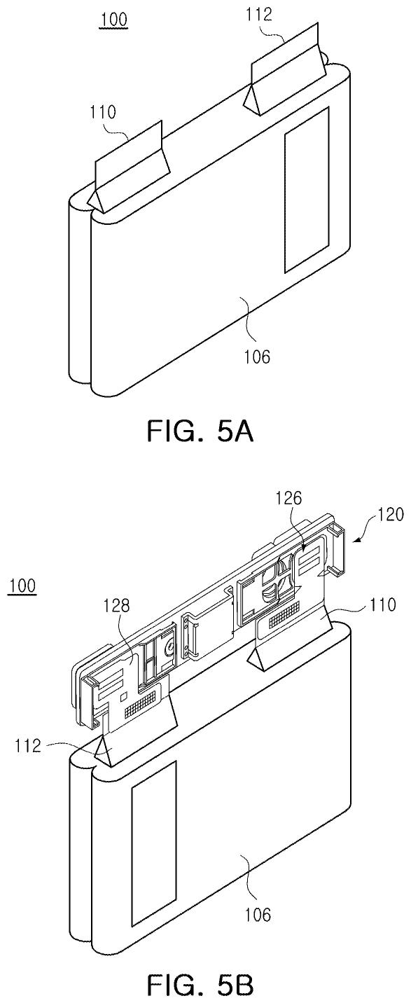

FIGS. 5A and 5B are views illustrating a connection between the jelly roll 106 and the upper cap assembly 120. The battery cell 100 may include the jelly roll 106 and/or the upper cap assembly 120. For example, FIG. 5A illustrates a jelly roll 106 having the cathode foil 112 and the anode foil 110. FIG. 5B illustrates connection of the cathode foil 112 to the cathode terminal 128 and connection of the anode foil 110 to the anode terminal 126 on the upper cap assembly 120. For example, the cathode foil 112 may be connected to the second cathode terminal (e.g., the second cathode terminal 128b in FIG. 2C), and the anode foil 110 may be connected to the second anode terminal (e.g., the second anode terminal 126b in FIG. 2C). The cathode foil 112 and the anode foil 110 may provide baseline dimensions that the present disclosure will improve to reduce resistance between the cathode foil 112 and the cathode terminal 128. The dimensions of the cathode foil 112 and the anode foil 110 may increase to increase a contact area between the cathode foil 112 and the anode foil 110 and the cathode terminal 128 and the anode terminal 126. An increase in the contact area may lead to a decrease in resistance.

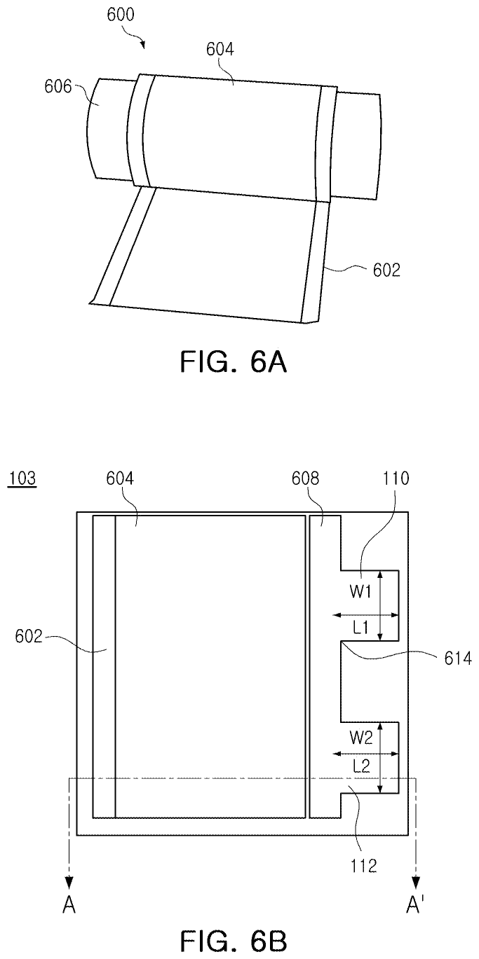

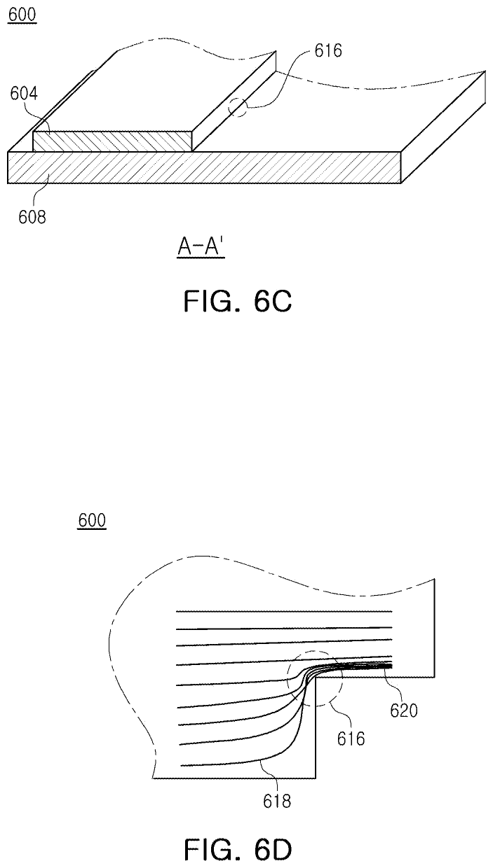

FIGS. 6A, 6B, 6C, and 6D are views illustrating a foil roll and die-cutting process according to a comparative example.

FIG. 6A illustrates a foil roll 600 formed of a foil 602. The foil roll 600 may include an active material 604 and a foil 602. The foil 602 may be aluminum for the cathode foil 112 or copper for the anode foil 110. The foil 602 may be coated with the active material 604, such as carbon or lithium. The foil 602 may be wrapped around the roll 606. For example, the foil 602 coated with the active material 604 may be wound onto the roll 606. The active material 604 may be referred to as an electrode or electrode plate.

FIG. 6B illustrates a die-cutting process for cutting the cathode foil 112 and the anode foil 110 into desired sizes and shapes. For example, FIG. 6B illustrates an electrode plate 103 including the active material 604, the cathode foil 112, and the anode foil 110. An original shape of the foil 602 is illustrated around a shape of the die-cut foil 608. The die-cutting process is generally incorporated into a roll-to-roll process during which a plurality of cutting dies (not shown) may be used to cut the foil 602 from top to bottom to desired dimensions. The foil 602 cut to the desired dimensions may be referred to as the die-cut foil 608. For example, the cathode foil 112 may be manufactured to have a second length L2 and a second width W2, and the anode foil 110 may be manufactured to have a first length L1 and a first width W1.

According to an embodiment, the die-cutting process may generate an electrode corner 614 that may cause increased resistance and current crowding effects. The current crowding effect may be referred to as a current bottleneck.

Although the cathode foil 112 and the anode foil 110 are illustrated in the same layer in FIG. 6B, the cathode foil 112 is spaced apart from the anode foil 110. For example, the battery cell 100 includes a separator (not shown) located between the cathode foil 112 and the anode foil 110. Contact between the cathode foil 112 and the anode foil 110 may be prevented by the separator.

Although FIG. 6B illustrates the active material 604 disposed on the foil 602 or the die-cut foil 608, the active material 604 may include a positive electrode active material applied on cathode foil 112 and a negative electrode active material applied on the anode foil 110. According to an embodiment, the positive electrode active material may include a material (e.g., slurry) capable of providing lithium ions. For example, the positive electrode active material may include at least one of nickel cobalt manganese, nickel cobalt aluminum, lithium iron phosphate, lithium manganese oxide, or lithium cobalt oxide.

According to an embodiment, the negative electrode active material may include a material (e.g., slurry) capable of storing or releasing lithium ions transferred from the positive electrode active material. For example, the negative electrode active material may include at least one of graphite, graphene, silicon dioxide, titanium dioxide, or lithium titanate.

FIG. 6C illustrates an active material boundary portion 616 between the active material 604 and the die-cut foil 608. The active material boundary portion 616 generates a vertical angle at which current needs to flow at the edge. In an embodiment, the active material boundary portion 616 may be defined as a portion of a surface of the active material 604.

FIG. 6D illustrates current flow near the active material boundary portion 616. As current lines 618 move past the active material boundary portion 616, the current lines are forced to be closer together, resulting in a crowding effect as shown in a region 620. Current crowding at the active material boundary portion 616 may cause the active material 604 to migrate to the foil to cause the prismatic battery cell 100 to fail. For example, heat may be generated in a portion in which current crowding occurs (e.g., the active material boundary portion 616). The battery cell 100 may be damaged due to the heat generation.

In an embodiment, the region 620 may be a portion in which the shape of the active material 604 or the shape of the die-cut foil 608 changes. For example, the region 620 may be a portion of the active material 604 in which a width is reduced relative to other adjacent portions or may form a corner portion of the active material 604. In the region 620, current flow may be concentrated. The region 620 may be referred to as a confluent region or a dense region.

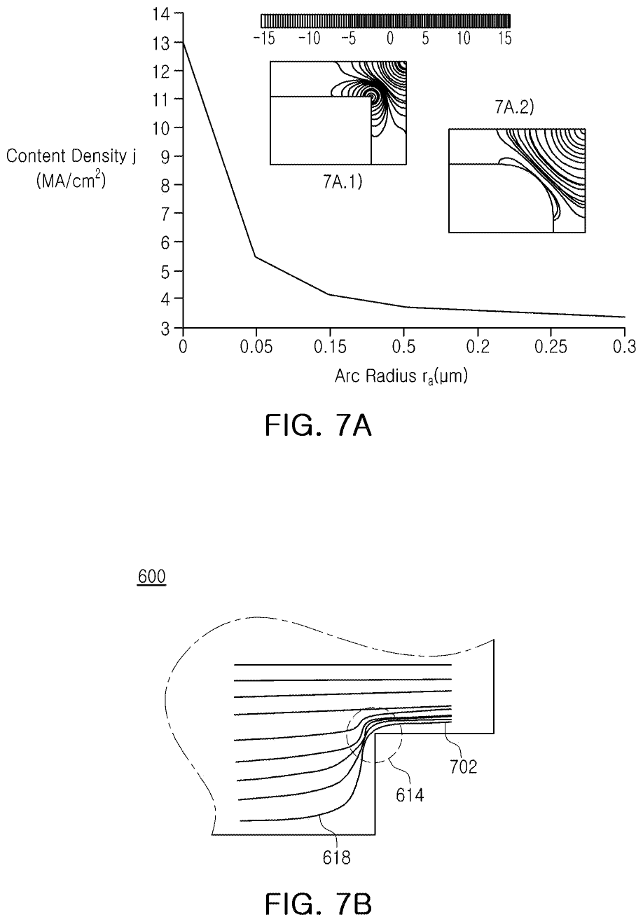

FIG. 7A illustrates a relationship between an arc radius and current density. Current crowding occurs due to peaks in current density in a region of high electric field strength. Corners are regions in which current crowding is common, and an orthogonal angle of an interconnected structure is a region with the highest current density. As the arc radius of the substrate or structure (e.g. the foil) decreases, the current density may increase as illustrated in FIG. 7A.1). As the arc radius increases, the current density may decrease as illustrated in FIG. 7A.2). FIG. 7B illustrates current crowding near the electrode corner 614. For example, FIG. 7B is a view illustrating current crowding at the electrode corner 614 and/or a region 702 of the foil roll 600. A current line 618 approaching the electrode corner 614 results in current crowding in a region 702. For example, current crowding may occur at the electrode corner 614. Arc radius may be referred to as radius of curvature.

In an embodiment, the region 702 may be a portion in which the shape of the active material 604 or the shape of die-cut foil 608 changes. For example, the region 702 may be a portion of the active material 604 in which a width is reduced relative to other adjacent portions or may form a corner portion of the active material 604. In the region 702, current flow may be concentrated. The region 702 may be referred to as a confluent region or a dense region.

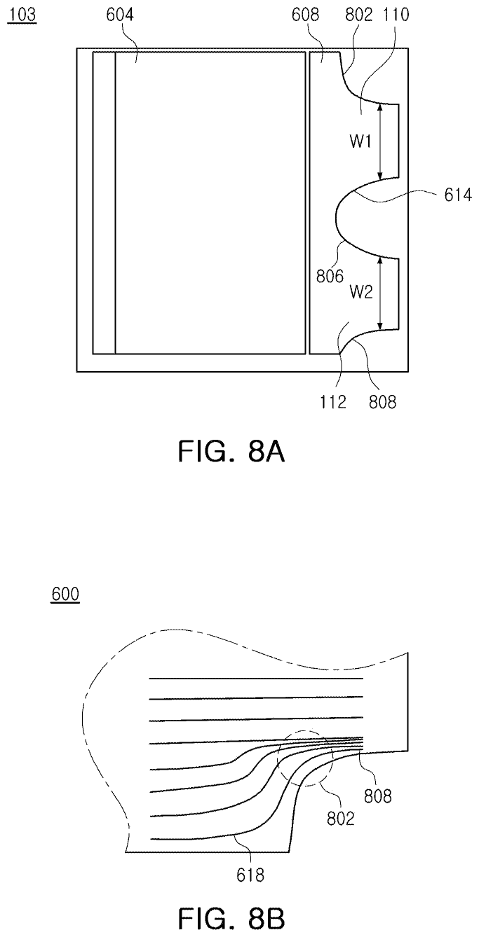

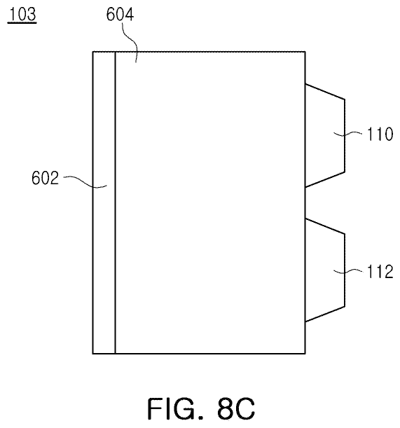

FIGS. 8A, 8B, and 8C are views illustrating a foil having a variable width according to an embodiment. For example, an electrode plate 103 of FIG. 8A may include arcuate foils 110 and 112. The electrode plate 103 of FIG. 8C may include tapered foils 110 and 112. By changing the die-cutting process to a curved die cutter, arcs may be generated in regions 806 and 808 of the cathode foil 112 and regions 802 and 804 of the anode foil 110. Replacing the corner 614 of the foil 608 with a tapered metal foil increases the arc radius of a joint.

FIG. 8B illustrates current flow in the arcuate region 802. The current line 618 passes through the arcuate region 802. Current crowding occurring in FIG. 8B is less than current crowding occurring in the region 702 in FIG. 7B, which illustrates current flow past the electrode corner 614, due to an increased arc radius. A description of current flow in the region 802 may be applied to other regions 804, 806, and 808.

According to an embodiment, at least a portion of the regions 802 and 804 may include a curved surface. For example, the foil 608 may include the regions 802 and 804in which are least a portion is curved. According to an embodiment, the regions 802 and 804 of the foil 608 may be interpreted as edges of an uncoated portion of the foil 608 to which the active material 604 is not attached. A width (e.g., a length in the X-axis direction) of the foil 608 may be variably changed. For example, the widths of regions 802 and 804 of the foil 608 may have a tapered shape (e.g., FIG. 8C) or a curved shape. According to an embodiment, current crowding may be reduced as the curvature of the regions 802 and 804 of the foil 608 is reduced. In this document, the description of the foil 608 may be applied to the cathode foil 112 or the anode foil 110.

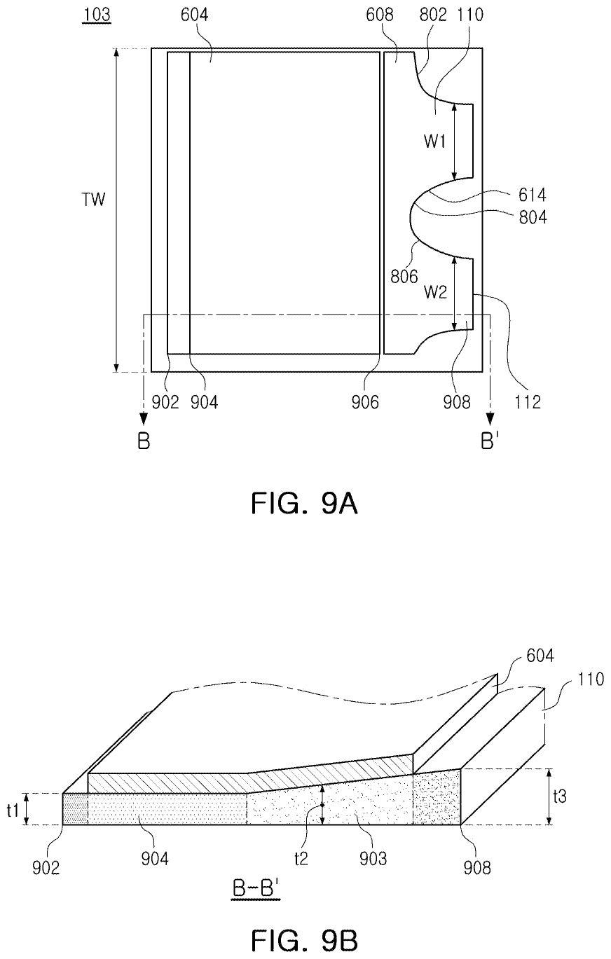

FIGS. 9A and 9B illustrate a metal foil with a tapered thickness. As mentioned above, the arc radius may increase in the X, Y or Z direction to reduce current crowding.

FIG. 9A is a view illustrating an electrode plate including a foil having a variable thickness. For example, FIG. 9A illustrates a jelly roll 106 with a tapered metal foil. FIG. 9B is a perspective view of a cross-section B-B′ of FIG. 9A. The anode foil 110 may be formed to have partially different thicknesses. A description of the thickness or structure of the anode foil 110 may be applied to the cathode foil 112. However, the structures of the cathode foil 112 and the anode foil 110 are not limited to the curved or arc-shaped structure illustrated in FIG. 9A. For example, the jelly roll 106 of FIG. 6B may include a tapered metal foil.

According to an embodiment, the anode foil 110 may include a protruding region 902 having a substantially uniform first thickness t1. The protruding region 902 may be a portion of the anode foil 110 not covered with the active material 604. The protruding region 902 may form a portion of the edge of the anode foil 110. The protruding region 902 may be located in a direction opposite to a third region 908.

According to an embodiment, the anode foil 110 may include a first region 904 having a first thickness t1, which is substantially uniform, having the active material 604 thereon. The first region 904 of the anode foil 110 may be covered with the active material 604. According to an embodiment, the first region 904 may have the first thickness t1 and may be referred to as a portion of the foil (e.g., the cathode foil 112 or the anode foil 110) covered with the active material 604.

According to an embodiment, the anode foil 110 may include a second region 906 having a second thickness t2 thicker than the first thickness t1. The second region 906 may extend from the first region 904. For example, the second region 906 may be located between the first region 904 and the third region 908.

The second thickness t2 of the second region 906 may be different for each position. For example, the second thickness t2 of the second region 906 may be thicker in a direction toward the third region 908, relative to the first region 904. According to an embodiment, the second region 906 may have a tapered shape. According to another embodiment, the second region 906 may have an arc or step shape. According to an embodiment, the second region 906 may have the second thickness t2 and may be referred to as a portion of a foil (e.g., the cathode foil 112 or the anode foil 110) covered with the active material 604.

According to an embodiment, the anode foil 110 may include a third region 908 having a third thickness t3 without the active material 604 thereon. The third thickness t3 may be formed to be greater than or equal to the second thickness t2. In an embodiment, the thickness of the third region 908 may have at least the second thickness. The third region 908 may not be covered with the active material 604. For example, the third region 908 may protrude or extend with respect to the second region 906.

According to an embodiment, the third thickness t3 of the third region 908 may be different for each location. For example, the third thickness t3 of the third region 908 may decrease in a direction toward the second region 906. According to an embodiment, the second region 906 may have a tapered shape. According to another embodiment, the second region 906 may have an arc or step shape. According to an embodiment (not shown), the third thickness t3 of the third region 908 may be substantially uniform.

According to an embodiment, the third region 908 may extend from the second region 906 and may be referred to as a portion of the foil (e.g., the cathode foil 112 or the anode foil 110) not covered with the active material 604. In an embodiment, the third region 908 may be referred to as an uncoated portion.

Due to an increase in the thickness from the first region 904 to the second region 906 and the third region 908, the foils 110 and 112 may be formed to have a tapered shape. The resulting tapering or tapered shape allows current to flow less crowded due to the larger volume of conductive material with less impact. A lower resistance allows current to flow more freely, reduces discontinuity, and reduces IR effects between the foils 110 and 112 and the active material 604. For example, the amount of heat generated by the current in the foils 110 and 112 and/or the active material 604 may be reduced. Therefore, the foils 110 and 112 having a tapered shape are less likely to fail at the corner when heated by a current. In an embodiment, the foils 110 and 112 may be referred to as metal foils.

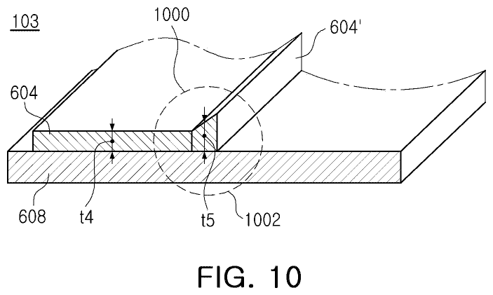

FIG. 10 illustrates an electrode plate including an active material having a variable thickness according to an embodiment. For example, FIG. 10 illustrates a tapered active material 1000.

Referring to FIG. 10, the electrode plate 103 may include the active material 604 and the metal foil 608. The active material 604 may be additionally added to the die-cut metal foil 608 at an edge region 1002 of the active material 604 to reduce current crowding and lower resistance. According to an embodiment, the active material 604 is coated to have a fourth thickness t4 on the metal foil. In the edge region 1002, an additional active material 604′ may be applied at a fifth thickness t5 greater than the fourth thickness t4. This may be conducted while applying the active material 604 slurry to the metal foil. In an embodiment, the slurry is applied in a single operation during which a portion of the slurry is guided toward the edge region 1002. In another embodiment, after applying the active material 604 with the fourth thickness t4, which is substantially uniform, to the metal foil (e.g., the anode foil 110 or the cathode foil 112 in FIG. 9A), additional active material 604′ slurry may be applied to the edge region 1002. The functions performed in the processes and methods may be implemented in different orders. In addition, outline operations and actions are provided as examples only, and some of the operations and actions may be optional, the operations and actions may be combined as fewer operations and actions or may be extended to additional operations and actions without detracting from the essence of the disclosed embodiments.

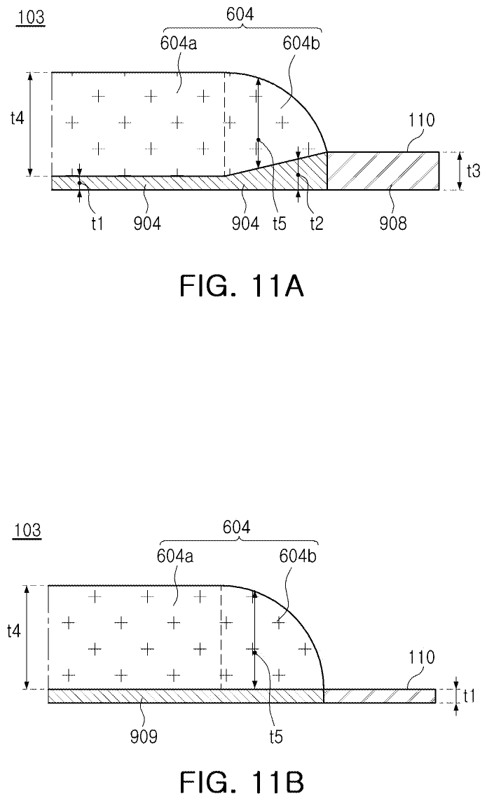

FIG. 11A is a schematic diagram of an electrode assembly including a metal foil and an active material according to an embodiment. FIG. 11B is a schematic diagram of an electrode plate including an active material having a variable thickness according to an embodiment.

Referring to FIGS. 11A and 11B, the electrode plate 103 may include the anode foil 110 and the active material 604. The anode foil 110 and/or the active material 604 may have different thicknesses by portions. The description of the anode foil 110 and the active material 604 previously described (e.g., FIGS. 1, 6B, and 9B) may be applied to the anode foil 110 and the active material 604 of FIGS. 11A and 11B. The description of the anode foil 110 of FIGS. 11A and 11B may be applied to the cathode foil 112.

Referring to an embodiment (e.g., FIG. 11A), the anode foil 110 and the active material 604 may have different thicknesses by portions.

The anode foil 110 may include a first region 904, a second region 906, and a third region 908. The first region 904 may have a first thickness t1 and be covered with the active material 604. The second region 906 may be formed to have a second thickness t2 thicker than the first thickness t1 and may be covered with the active material 604. The third region 908 may not be covered with the active material 604. The third region 908 may be formed to have a third thickness t3 greater than or equal to the second thickness t2. The second region 906 may be located between the first region 904 and the third region 908. According to an embodiment, the third thickness t3 of the third region 908 may be formed to have a substantially uniform thickness.

The active material 604 may cover at least a portion of the anode foil 110. The active material 604 may cover the first region 904 and the second region 906.

According to an embodiment, the active material 604 may cover a portion of the anode foil 110. For example, the active material 604 may be disposed on the first region 904 and the second region 906 of the anode foil 110.

According to an embodiment (e.g., FIG. 11A or 11B), the active material 604 may partially have a different thickness. For example, the active material 604 may include a first cover region 604a having a substantially uniform thickness and a second cover region 604b having a thickness different by portions.

The first cover region 604a may be formed to have a substantially uniform fourth thickness t4. The second cover region 604b may be formed to have a fifth thickness t5 less than the fourth thickness t4. The fifth thickness t5 of the second cover region 604b may increase in a direction toward the first cover region 604a. In an embodiment, the second cover region 604b may be formed to have an arch shape. According to an embodiment (not illustrated), the second cover region 604b may be formed to have a tapered shape.

According to an embodiment, the first cover region 604a may be disposed on the first region 904 of the anode foil 110. The second cover region 604b may be disposed on the second region 906 of the anode foil 110.

Since the second cover region 604b, which is thinner than the first cover region 604a, is disposed on the second region 906 thicker than the first region 904, a thickness difference between portions of the electrode plate 103 may be reduced. According to an embodiment, the second region 906 may be formed to be less than half the length of the first region 904. Since the second region 906 is formed to be less than half the length of the first region 904, the amount of the active material 604 applied to the first region 904 may be greater than the amount of the active material 604 applied to the second region 906. Since the volume of the first cover region 604a applied to the first region 904 is larger than the volume of the second cover region 604b covering the second region 906, reduction in energy capacity of the electrode plate 103 may be prevented.

Resistance of the electrode plate 103 may be substantially proportional to a width of the electrode plate 103 and substantially inversely proportional to a thickness of the electrode plate 103. When the width (e.g., a first width W1 and a second width W2) of the third region 908 is shorter than a total width TW of the electrode plate 103, a magnitude of resistance generated in the third region may increase.

According to an embodiment of the present document, since the third thickness t3 of the third region 908 is formed to be greater than the first thickness t1 of the first region 904, the electrode plate 103 having a substantially uniform resistance value may be provided. According to an embodiment, a ratio of the third thickness t3 to the first thickness t1 may be determined based on the total width TW of the electrode plate 103 and the width of the uncoated portion. According to an embodiment, the ratio of the first thickness t1 of the first region 904 to the third thickness t3 of the third region 908 may be substantially the same as the ratio of the first width W1 of the third region 908 of the anode foil 110 to the total width TW of the electrode plate 103 or the ratio of the second width W2 of the third region 908 of the cathode foil 112 to the total width TW of the electrode plate 103. For example, the total width TW of the electrode plate 103 may be formed to be about three times the first width W1, and the third thickness t3 may be formed to be about three times the first thickness t1.

According to an embodiment of the present disclosure, an increase in resistance and heat generation due to current bottleneck may be reduced.

Only specific examples of implementations of certain embodiments are described. Variations, improvements and enhancements of the disclosed embodiments and other embodiments may be made based on the disclosure of this patent document.

What is claimed is:

1. A battery cell comprising:
an electrode assembly comprising an active material and a foil; and
a can accommodating the electrode assembly,
wherein the foil includes:
a first region covered with the active material and having a first thickness;
a second region covered with the active material and extending from the first region; and
a third region protruding from the second region,
wherein the third region has a third thickness, greater than the first thickness, and
the second region has a second thickness, greater than the first thickness and less than the third thickness.

2. The battery cell of claim 1, wherein the second region is formed to gradually be thicker as it is closer to the third region than the first region.

3. The battery cell of claim 1, wherein the first thickness is uniform, and the second region is tapered.

4. The battery cell of claim 1, wherein the third region is not covered with the active material.

5. The battery cell of claim 1, wherein the third thickness is uniform.

6. The battery cell of claim 1, wherein the third thickness increases in a direction away from the second region.

7. The battery cell of claim 1, wherein the active material includes a first cover region having a fourth thickness, being uniform, and a second cover region having a fifth thickness less than the fourth thickness.

8. The battery cell of claim 7, wherein the first cover region is disposed on the first region, and the second cover region is disposed on the second region.

9. The battery cell of claim 1, wherein a ratio of the third thickness to the first thickness is equal to a ratio of a total width of the electrode assembly to a sum of the width of the third region.

10. The battery cell of claim 1, wherein the foil has an arcuate or tapered width.

11. The battery cell of claim 1, wherein the foil includes a protruding region protruding from the first region and not covered with the active material, and the first region is located between the protruding region and the second region.

12. The battery cell of claim 1, wherein
the foil includes a cathode foil and an anode foil, and
the active material includes a positive electrode active material applied on the cathode foil and a negative electrode active material applied on the anode foil.

13. The battery cell of claim 12, further comprising:
an upper cap assembly connected to the can and including a cathode terminal connected to the third region of the cathode foil and an anode terminal connected to the third region of the anode foil.
